(19) United States
(12) Patent Application Publication
(10) Pub. No.: US 2025/0115147 A1
(43) Pub. Date: Apr. 10, 2025

(54) Solar Power-Based System and Method for Recharging Electric Vehicles

(71) Applicant: Phillip Hentz, Lambert, MS (US)

(72) Inventor: Phillip Hentz, Lambert, MS (US)

(21) Appl. No.: 18/827,939

(22) Filed: Sep. 9, 2024

Related U.S. Application Data
(60) Provisional application No. 63/588,060, filed on Oct. 5, 2023.

(51) Int. Cl. B60L 53/51; B60L 53/16; B60L 58/12; B60L 58/20; H02J 7/35; H02S 20/30

(52) U.S. Cl. CPC B60L 53/51; B60L 53/16; B60L 58/12; B60L 58/20; H02J 7/35; H02S 20/30; B60L 2210/10; B60L 2210/30

(57) ABSTRACT

A solar charging system for electric vehicles that includes high-efficiency solar panels mounted on the outer surface of an electric vehicle is disclosed. The system comprises photovoltaic cells for converting a broad spectrum of sunlight into electrical energy, even in low-light conditions with up to 25% efficiency. The solar panels are linked to the vehicle's charging port via an electrical conduit, and a charging module regulates the energy for charging both the main traction and auxiliary batteries. The system can be designed for easy retrofitting, utilizing an adhesive rear surface for secure attachment. In some embodiments, the solar panels include a hydrophobic coating for water repellence and debris removal, and heating elements that actuate automatically under a temperature of zero degrees centigrade to melt ice and snow.

### CROSS-REFERENCE TO RELATED APPLICATION

The present application claims priority to, and the benefit of, U.S. Provisional Application No. 63/588,060, which was filed on Oct. 5, 2023, and is incorporated herein by reference in its entirety.

### FIELD OF THE INVENTION

The present invention generally relates to the field of electric vehicles. More specifically, the present invention relates to a novel solar charging system for electric vehicles for charging both the main traction and auxiliary batteries of the electric vehicle. The system includes solar panels and solar panels that are linked to the vehicle's charging port via an electrical conduit including a charging module to regulate the energy for charging both the main traction and auxiliary batteries. The system can be integrated or retrofitted to meet the requirements of different users. Accordingly, the present disclosure makes specific reference thereto. Nonetheless, it is to be appreciated that aspects of the present invention are also equally applicable to other like applications, devices, and methods of manufacture.

### BACKGROUND

By way of background, electric vehicles (EVs) have become popular in the last few years as they are environmentally friendly and reduce the reliance on gasoline and fossil fuels. Diesel fuel, for example, is not only costly but is also harmful to the environment. Pollution from conventional vehicles' exhaust includes soot or particulate matter (PM), oxides of nitrogen (NOx) which contribute to the production of ground-level ozone (smog) and acid rain, Hydrocarbons (HC), and many other pollutants.

Electric vehicles do not cause pollution and are cost-effective while in use as well. With their low operating costs, many drivers opt to purchase electric vehicles as a way to save money on fuel costs. Government and vehicle manufacturers are also focusing on the production and adoption of electric vehicles. However, despite the mentioned advantages, the cost and inconvenience of charging electric vehicles can still be a deterrent for some potential buyers.

One of the biggest challenges faced by electric vehicle owners is the issue of charging their electric vehicles. Unlike conventional gasoline-powered vehicles, electric vehicles rely on batteries that are required to be recharged for powering the electric vehicle. Most of the public charging stations along major roadways lack electric vehicle charging stations. The problem is exacerbated on long trips and off-road trips. As a result, batteries of electric vehicles can lose power easily and frequently and can leave vehicle owners stranded. Accordingly, individuals need to plan their trips around stations equipped with electric vehicle charging stations, which is inefficient and time-consuming Also, electric vehicles often require more frequent stops for charging compared to gasoline-powered vehicles, and electric vehicle owners may need to stop more frequently to recharge their batteries, which can be disruptive to their daily routines and schedules.

Solar energy is used for generating electricity for homes and businesses, but it is still not utilized for recharging electric batteries of an EV. A system that uses solar power to charge an electric vehicle can solve the charging problems of the EVs as mentioned in the prior art.

Therefore, there exists a long-felt need in the art for a solar charging system for electric vehicle batteries. Additionally, there is a long-felt need in the art for solar panels that can be attached to an outer surface of an electric vehicle for absorbing solar energy and recharging electric batteries of EVs. Moreover, there is a long-felt need in the art for a charging system for electric vehicles that keeps charging the electric vehicle, thereby reducing the need for a user to stop at an electric vehicle charging station. Further, there is a long-felt need in the art for an EV solar charging system that enables electric power to be transferred from solar panels to an electric battery of the EV for recharging the battery. Furthermore, there is a long-felt need in the art for an innovative EV battery charging system that is safe, reliable, easy, and environmentally friendly. Also, there is a long-felt need in the art for solar panels that can be integrated or retrofitted to an outer surface of an electric vehicle. Finally, there is a long-felt need in the art for solar panels and a charging system that provides an EV with infinite or expanded electric power and obviates the need for the vehicle owner to stop and use an electric vehicle charging station.

The subject matter disclosed and claimed herein, in one embodiment thereof, comprises a charging system for use with an electric vehicle. The charging system comprises at least one solar panel installed on an outer surface of the electric vehicle, the solar panel is adapted to convert solar energy into electrical energy using a plurality of embedded photovoltaic cells, an electrical conduit couples the solar panel to a charging port for receiving the electrical energy, a charging module regulates the electrical energy to charge one or both main battery and auxiliary battery of the electric vehicle, wherein regulation can include adapting the voltage to meet requirements of the batteries. The solar panel can be transparent and includes a hydrophobic coating, one or more heating elements, and a rear adhesive surface for removably adhering to the outer surface of the vehicle.

In this manner, the solar charging system for electric vehicles of the present invention accomplishes all of the foregoing objectives and provides users with solar panels affixed directly to the roof area/outer surface of the vehicle. The solar panels connect directly to the internal vehicle battery, enabling electric power to be transferred from the panels to the battery. The system prevents vehicle owners from running out of battery power while on the road and being stranded. Further, the system overcomes the problem of inadequate electric vehicles charging stations for recharging the battery of electric vehicles.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a charging system for use with an electric vehicle. The charging system comprises at least one solar panel installed on an outer surface of the electric vehicle, the solar panel is adapted to convert solar energy into electrical energy, an electrical conduit couples the solar panel to a charging port for receiving the electrical energy, a charging module regulates the electrical energy to charge one or both main battery and auxiliary battery of the electric vehicle, wherein regulation can include adapting the voltage to meet requirements of the batteries.

In another aspect, the solar panel system installed on the electric vehicle comprises high-efficiency photovoltaic cells capable of absorbing a broad spectrum of sunlight, including in low-light conditions to enhance energy absorption and efficiency, achieving an efficiency rate of up to 25%.

In yet another embodiment, the solar panel system includes a hydrophobic coating to repel water and facilitate the removal of debris and dirt. Additionally, the solar panel system includes a plurality of heating elements that automatically activate to melt ice and snow when the ambient temperature drops below zero degrees centigrade.

In yet another aspect, the solar panel system is adaptable for retrofitting on electric vehicles and features an adhesive rear surface for attachment to the outer surface of the vehicle.

In yet another aspect of the present invention, the solar panel system allows for charging of the main traction battery and auxiliary battery while the electric vehicle is running and when stationary.

In a further embodiment of the present invention, an electric vehicle equipped with a solar charging system for recharging the traction battery of the electric vehicle is disclosed. The vehicle includes the traction battery and an auxiliary battery. A solar panel including a plurality of photovoltaic cells is disposed on a roof of the vehicle, the solar panel is connected to a charging port of the vehicle, wherein a charging module transmits the electric power from the solar panel to one or both the traction battery and the auxiliary battery. The solar panel includes one or more mounted panels for changing the orientation of the solar panel to maximize solar irradiance. Irradiance is the flux of radiant energy per unit area (normal to the direction of flow of radiant energy through a medium).

In yet another aspect, a method for recharging an electric vehicle battery is described. The method comprises the steps of absorbing solar energy by one or more solar panels installed on the roof of the vehicle. Converting the absorbed energy into electrical power by the photovoltaic cells included in one or more solar panels. Transmitting the electrical power to a charging port of the electric vehicle and recharging one or both traction battery and auxiliary battery of the electric vehicle, wherein when none of the traction battery and auxiliary battery require the electrical power, then storing the electrical power in a removable additional battery.

In yet another embodiment, the method includes the steps of monitoring the efficiency of the solar panels, monitoring the power output of the solar panels, and, activating and deactivating the solar panels charging system.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the electric vehicle solar panel system of the present invention installed in an electric vehicle in accordance with the disclosed structure;

FIG. 2 illustrates a perspective view showing the solar panel system being retrofitted on the electric vehicle in accordance with the disclosed structure;

FIG. 3 illustrates a flow chart depicting a process of recharging the internal batteries of an electric vehicle using the solar panel system of the present invention in accordance with the disclosed structure;

FIG. 4 illustrates a flow chart showing management of the electric power generated by the solar panel system in accordance with another embodiment of the present invention;

FIG. 5 illustrates an exemplary interface displayed by a smartphone application for controlling and monitoring the solar panel charging system in accordance with the disclosed structure;

FIG. 6 illustrates one potential embodiment of the solar panels installed on another EV in accordance with the disclosed structure; and

FIG. 7 illustrates one potential embodiment of the solar panels installed on a tractor trailer in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a solar charging system for electric vehicle batteries. Additionally, there is a long-felt need in the art for solar panels that can be attached to an outer surface of an electric vehicle for absorbing solar energy and recharging electric batteries of EVs. Moreover, there is a long-felt need in the art for a charging system for electric vehicles that keeps charging the electric vehicle, thereby reducing the need for a user to stop at an electric vehicle charging station. Further, there is a long-felt need in the art for an EV solar charging system that enables electric power to be transferred from solar panels to an electric battery of the EV for recharging the battery. Furthermore, there is a long-felt need in the art for an innovative EV battery charging system that is safe, reliable, easy, and environmentally friendly. Also, there is a long-felt need in the art for solar panels that can be integrated or retrofitted to an outer surface of an electric vehicle. Finally, there is a long-felt need in the art for solar panels and a charging system that provides an EV with infinite or expanded electric power and prevents the need for the vehicle owner to stop and use an electric vehicle charging station.

The present invention, in one exemplary embodiment, is a method for recharging an electric vehicle battery. The method comprises the steps of absorbing solar energy by one or more solar panels installed on the roof of the vehicle. Converting the absorbed energy into electrical power by the photovoltaic cells included in the one or more solar panels. Transmitting the electrical power to a charging port of the electric vehicle and recharging one or both traction battery and auxiliary battery of the electric vehicle, wherein when none of the traction battery and auxiliary battery require the electrical power, then storing the electrical power in a removable additional battery.

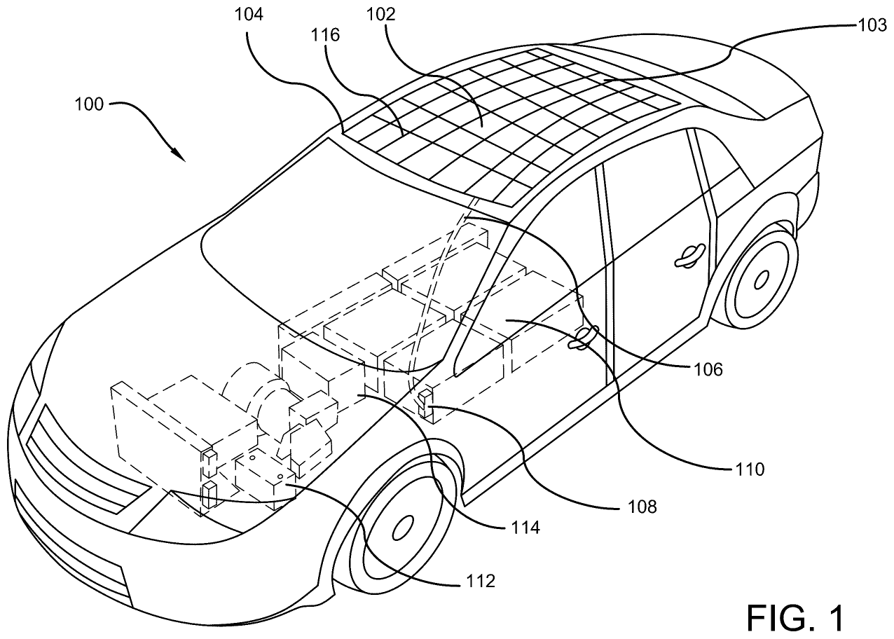

Referring initially to the drawings, FIG. 1 illustrates a perspective view of the electric vehicle solar panel system of the present invention installed in an electric vehicle in accordance with the disclosed structure. A solar panel system 102 is installed on the outer surface 104 of the electric vehicle 100, for example, installed on a roof of a vehicle. The solar panel 102 can be a continuous solar panel 102 and can also be a plurality of individual solar panels connected in a serial or parallel electrical connection. The solar panel 102 includes a plurality of photovoltaic cells 103 for absorbing solar energy falling on the solar panel 102 and converting the absorbed solar energy into electric power.

The solar panel system 102 preferably includes high-efficiency photovoltaic cells to capture a broader spectrum of sunlight, including low-light conditions for maximizing energy absorption and efficiency. The solar panel system 102 can have efficiency of up to 25% in absorbing solar irradiance. The solar panel system 102 is thin and can have a thickness in the range from about 1″ to about 4″ in different embodiments to reduce drag and improve efficiency. For providing electric power to recharge internal batteries of the electric vehicle 100, the solar panel 102 is connected to a charging port 108 via a wire or an electrical conduit 106. The electrical conduit 106 is embedded within the vehicle and can be in the form of an insulated wire as well.

A charging monitoring module 114 is coupled with the charging port 108 and is also adapted to monitor the charging state, voltage, temperature, and current charge requirements of the main traction battery 110 and auxiliary battery 112 of the electric vehicle 100. The charging monitoring module 114 regulates the electric power received from the charging port 108 which can include converting AC to DC power, reducing voltage of DC power, and more. The charging monitoring module 114 transmits the electric power to recharge one or both of the main traction battery 110 and auxiliary battery 112 to provide uninterrupted and consistent power to the electric vehicle 100.

In the preferred embodiment, the charging monitoring module 114 allows charging of the main traction battery 110 and auxiliary battery 112 when the electric vehicle 100 runs. In some embodiments, the batteries 110, 112 can be recharged using the solar panel 102 even when the vehicle 100 does not travel. The solar panel 102 continuously provides electric power, thereby reducing the dependence on the electric vehicle charging stations. The solar panel 102, conduit 106, and the module 114 form the charging system that can be integrated or retrofitted in any electric vehicle.

The solar panel 102 can include a hydrophobic coating for repelling water and to wash debris and dirt. Further, the solar panel 102 can include a plurality of heating elements 116 to melt ice and snow and the heating elements 116 can be automatically activated when the ambient temperature falls below a threshold such as zero degrees centigrade.

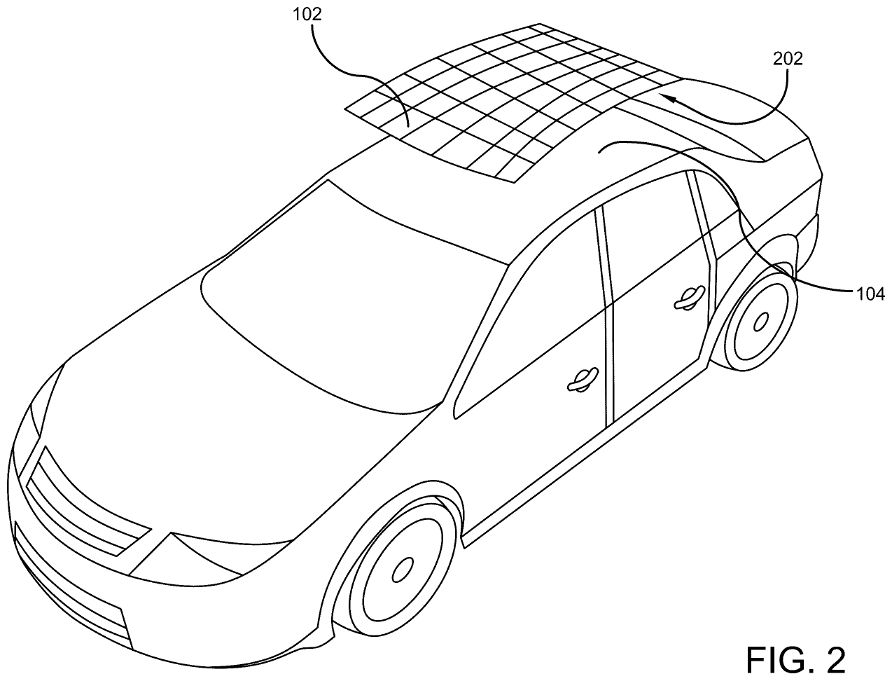

FIG. 2 illustrates a perspective view showing the solar panel system being retrofitted on the electric vehicle in accordance with the disclosed structure. In the present embodiment, the solar panel system 102 is used as an aftermarket product for providing energy efficiency to electric vehicle 100. The solar panel 102 is designed as per the outer surface 104 of the vehicle and includes an adhesive rear surface 202 that can be permanently or removably attached to the outer surface 104 of the vehicle 100. The electrical conduit 106 as illustrated in FIG. 1 is also installed in the vehicle along with the charging monitoring module 114. The retrofitted solar panel 102 does not blow in the wind and can also be installed on tiltable mounts allowing effective absorption of solar energy.

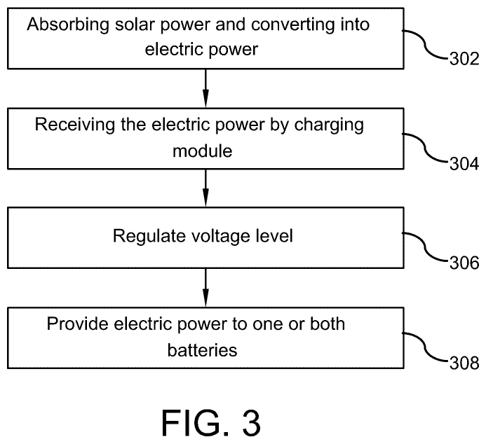

FIG. 3 illustrates a flow chart depicting a process of recharging the internal batteries of an electric vehicle using the solar panel system of the present invention in accordance with the disclosed structure. Initially, photovoltaic (PV) cells of the solar panel 102 absorb sunlight and generate an electric current (Step 302). More specifically, when sunlight hits the PV cells, the sunlight excites electrons in the semiconductor material of the PV cells, creating electron-hole pairs. This creates an electric field which allows free electrons to flow in a specific direction, generating an electric current.

Then, the electricity from the solar panels 102 is received by the charging monitoring module 114 (Step 304). The charging monitoring module 114 manages the rate at which the internal batteries are charged to prevent overcharging or damage. Thereafter, the charging monitoring module 114 regulates the varying voltages produced by the solar panel 102 to match the specifications of the EV batteries 110, 112 (Step 306). Finally, the regulated DC power from the charging module 114 charges the batteries 110, 112 directly (Step 308).

It will be apparent to a person skilled in the art that the EV 100 is considered with dual battery systems 110, 112, a main or traction battery 110 used for propulsion, and an auxiliary battery for vehicle accessories. The solar charging system can be designed to charge either one or both, depending on the design of the EV 100. In some EVs, the auxiliary battery 112 can receive power only from the main battery 110, and in such cases, the solar panel 102 provides power only to the main battery 110.

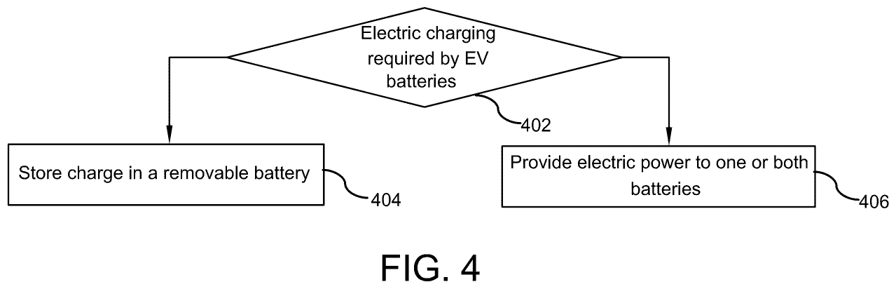

FIG. 4 illustrates a flow chart showing management of the electric power generated by the solar panel system in accordance with another embodiment of the present invention. In the present embodiment, the charging monitoring module 114 monitors the charging state of one or both batteries 110, 112 and determines if the batteries require further charging (Step 402). The determination can be made continuously and in real-time. In case, it is determined that the batteries do not require charging, then, the electric power of the solar panel system can be stored in an additional and removable battery which can be installed along with the solar panel system (Step 404). The power from the removable battery can be used for additional uses such as illuminating a light source, charging electronic devices, and can also be used for recharging the batteries 110, 112. If it is determined that the batteries 110, 112 require electric charging, then the electric power of the solar panel system is used for recharging one or both the batteries 110, 112 (Step 406).

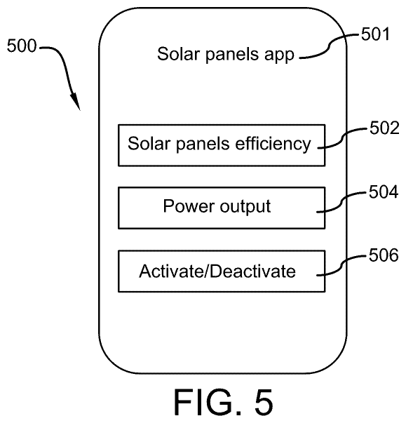

FIG. 5 illustrates an exemplary interface displayed by a smartphone application for controlling and monitoring the solar panel charging system in accordance with the disclosed structure. The interface 500 displayed by the smartphone application 501 can be displayed on a smartphone or alternatively on a dashboard of the EV. The interface 500 includes a solar panels efficiency option 502 for allowing users to view and monitor the efficiency of the solar panels 102 installed on an electric vehicle. In some embodiments, tilt or orientation of the solar panels 102, relative to the vehicle's roof, for example, can be altered to increase the efficiency of the solar panels 102.

A power output option 504 allows users to view the voltage of the electric power generated by the solar panels 102. The power output can be displayed in multiple graphs and may indicate malfunctioning of the solar panels 102. For selective activation and deactivation of the solar panel charging system, an activate/deactivate option 506 is provided. The system may be deactivated when charging from solar panels 102 is not required by a user.

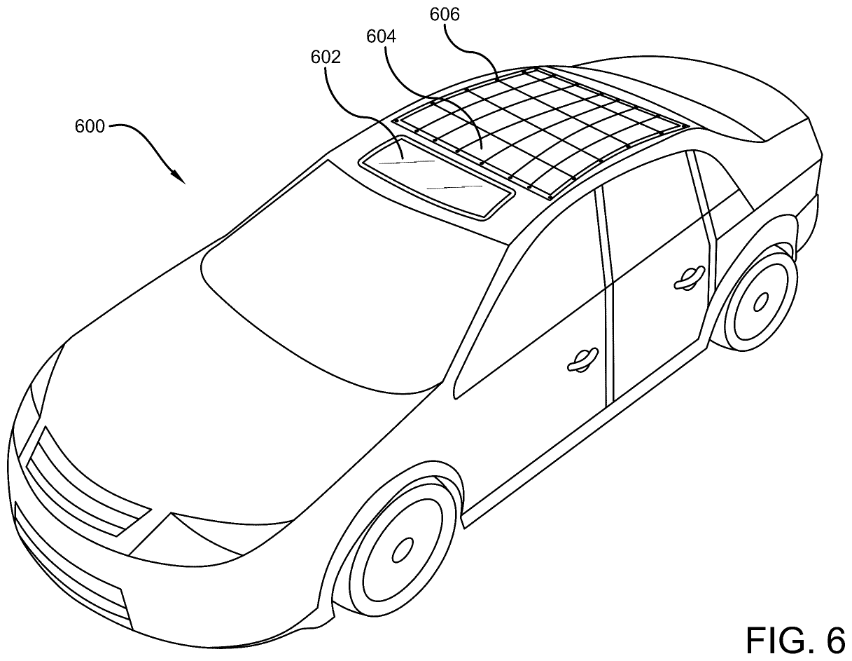

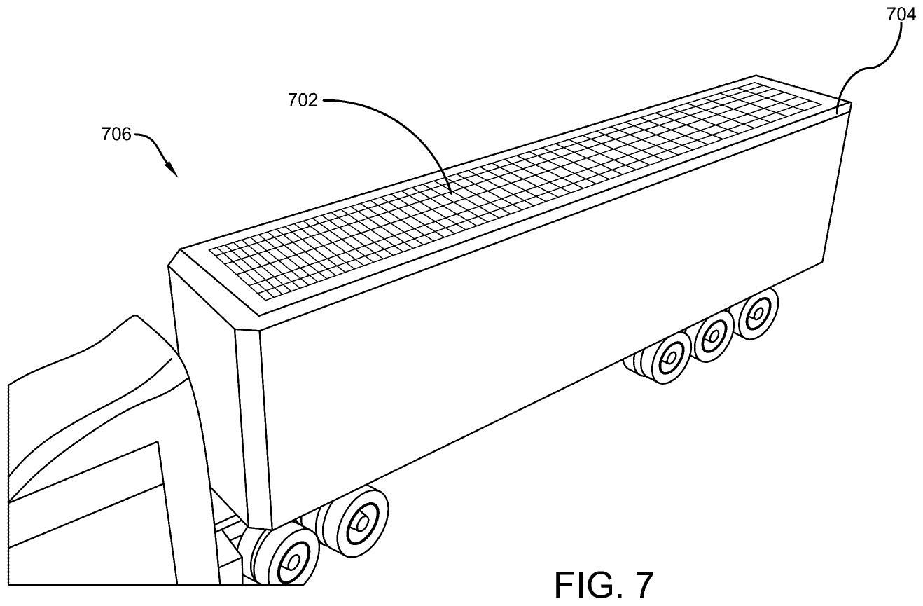

FIGS. 6 and 7 illustrate different embodiments of the solar panels installed on another EV and a tractor trailer respectively in accordance with the disclosed structure. As illustrated in FIG. 6, the EV 600 has a sunroof 602 and the solar panel 604 is designed to not overlap the sunroof 602. In some embodiments, the solar panel 604 can be transparent to maintain the aesthetics of the vehicle 600. A plurality of LED lights 606 can be mounted around a perimeter of the solar panel 604 for selective actuation in order to provide light to charge the solar panel 604 when the LED lights 606 are in the ON position. Selective actuation can be initiated at night or when the vehicle is parked indoors. It is to be appreciated that actuation of the LED lights 606 are used for supplemental charging of the solar panel 604 when the sun is not shining on the solar panel 604.

Referring now to FIG. 7, the solar panel 702 is integrated or removably attached to the top surface 704 of the tractor trailer 706 and can provide electric power to recharge internal batteries for propulsion and running the tractor trailer 706.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “solar panel system”, “solar panels”, “solar panel”, and “continuous solar panel” are interchangeable and refer to the solar panel system 102, 604, 702 of the present invention for electric vehicles.

Notwithstanding the foregoing, the solar panel system 102, 604, 702 of the present invention can be of any suitable size and configuration as is known in the art without affecting the overall concept of the invention, provided that it accomplishes the above-stated objectives. One of ordinary skill in the art will appreciate that the solar panel system 102, 604, 702 as shown in the FIGS. is for illustrative purposes only, and that many other sizes and shapes of the solar panel system 102, 604, 702 are well within the scope of the present disclosure. Although the dimensions of the solar panel system 102, 604, 702 are important design parameters for user convenience, the solar panel system 102, 604, 702 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A solar panel system for an electric vehicle, the solar panel system comprising:
a solar panel;
a plurality of photovoltaic cells;
a charging port;
an electrical conduit; and
a charging monitoring module;
wherein said charging monitoring module connected to said charging port for monitoring a charging state of a main vehicle traction battery and an auxiliary battery of the electric vehicle;
wherein said photovoltaic cells absorb solar energy falling on said solar panel and converting the absorbed solar energy into electric power; and
further wherein said charging state including a voltage, a temperature, and a current charge requirement of said main vehicle traction battery and said auxiliary battery.

2. The solar panel system for an electric vehicle of claim 1, wherein said solar panel having a thickness from 1″ to 4″.

3. The solar panel system for an electric vehicle of claim 1, wherein said charging monitoring module regulates electric power received from said charging port.

4. The solar panel system for an electric vehicle of claim 3, wherein said charging monitoring module converts AC to DC power.

5. The solar panel system for an electric vehicle of claim 4, wherein said charging monitoring reduces voltage of DC power.

6. The solar panel system for an electric vehicle of claim 5, wherein said charging monitoring module transmits electric power to recharge at least one of said main traction battery and said auxiliary battery for supplying power to the electric vehicle.

7. A solar panel system for an electric vehicle, the solar panel system comprising:
a solar panel;
a plurality of photovoltaic cells;
a charging port;
an electrical conduit;
a charging monitoring module; and
a plurality of heating elements;
wherein said solar panel having a hydrophobic coating;
wherein said plurality of heating elements integrated with said solar panel for melting snow and ice;
wherein said charging monitoring module connected to said charging port for monitoring a charging state of a main vehicle traction battery and an auxiliary battery of the electric vehicle;
wherein said photovoltaic cells absorb solar energy falling on said solar panel and converting the absorbed solar energy into electric power; and
further wherein said charging state including a voltage, a temperature, and a current charge requirement of said main vehicle traction battery and said auxiliary battery.

8. The solar panel system for an electric vehicle of claim 7, wherein said plurality of heating elements automatically actuated when ambient temperature is less than zero degrees centigrade.

9. The solar panel system for an electric vehicle of claim 8, wherein said solar panel having a thickness from 1″ to 4″.

10. The solar panel system for an electric vehicle of claim 8, wherein said charging monitoring module regulates electric power received from said charging port.

11. The solar panel system for an electric vehicle of claim 10, wherein said charging monitoring module converts AC to DC power.

12. The solar panel system for an electric vehicle of claim 11, wherein said charging monitoring module reduces voltage of DC power.

13. The solar panel system for an electric vehicle of claim 12, wherein said charging monitoring module transmits electric power to recharge at least one of said main traction battery and said auxiliary battery for supplying power to the electric vehicle.

14. A method of charging batteries of an electric vehicle, the method comprising the steps of:
providing a solar panel, a plurality of photovoltaic cells, a charging port, an electrical conduit, a charging monitoring module, and a plurality of heating elements, wherein said solar panel having a hydrophobic coating;
integrating said plurality of heating elements with said solar panel for melting snow and ice;
monitoring a charging state of a main vehicle traction battery and an auxiliary battery of the electric vehicle with said charging monitoring module connected to said charging port;
absorbing solar energy with said photovoltaic cells;
converting the absorbed solar energy into electric power; and
monitoring said charging state including a voltage, a temperature, and a current charge requirement of said main vehicle traction battery and said auxiliary battery.

15. The method of charging batteries of an electric vehicle of claim 14 further comprising a step of automatically actuating said plurality of heating elements when ambient temperature is less than zero degrees centigrade.

16. The method of charging batteries of an electric vehicle of claim 14 further comprising a step of actuating a plurality of LED lights around said solar panel for charging said solar panel when said solar panel is not absorbing solar energy.

17. The method of charging batteries of an electric vehicle of claim 15, wherein said charging monitoring module regulates electric power received from said charging port.

18. The method of charging batteries of an electric vehicle of claim 17, wherein said charging monitoring module converts AC to DC power.

19. The method of charging batteries of an electric vehicle of claim 18, wherein said charging monitoring module reduces voltage of DC power.

20. The method of charging batteries of an electric vehicle of claim 19, wherein said charging monitoring module transmits electric power to recharge at least one of said main traction battery and said auxiliary battery for supplying power to the electric vehicle.
